(19) United States
(12) Patent Application Publication
(10) Pub. No.: US 2025/0384636 A1
(43) Pub. Date: Dec. 18, 2025

(54) MECHANISM TO CONTROL THE REFRESH RATE OF THE REAL-ENVIRONMENT COMPUTATION FOR AUGMENTED REALITY (AR) EXPERIENCES

(71) Applicant: InterDigital CE Patent Holdings, SAS, Paris (FR)

(72) Inventors: Patrice Hirtzlin, Betton (FR); Jaya Rao, Montreal (CA); Xavier De Foy, Kirkland (CA); Michael Starsinic, Newtown, PA (US); Etienne Faivre d'Arcier, Saint Gonlay (FR); Pierrick Jouet, Rennes (FR); Sylvain Lelievre, Montgermont (FR); Serge Defrance, Rennes (FR); Loic Fontaine, Noyal sur Vilaine (FR); Ralph Neff, San Diego, CA (US)

(21) Appl. No.: 19/130,061

(22) PCT Filed: Nov. 29, 2023
(86) PCT No.: PCT/EP2023/083521

§ 371 Date: May 14, 2025

(30) Foreign Application Priority Data
Dec. 15, 2022 (EP) 22306886.7

(51) Int. Cl. G06T 19/00; G06F 3/01

(52) U.S. Cl. CPC G06T 19/006; G06F 3/01

(57) ABSTRACT

Example embodiments provide a mechanism enabling a user equipment, UE, to adapt the environment-computation refresh rate to improve user extended reality, XR, experience and limit resource usage. An example method includes obtaining sensor data describing a user's environment: obtaining information indicating at least one factor from among: user movement information, environment evolution information, network condition information, or battery life information: determining a candidate environment-computation refresh rate based on the at least one factor: selecting an environment-computation refresh rate as a minimum of: the candidate environment-computation refresh rate and a maximum environment-computation refresh rate; and updating a real-environment computation using the selected environment-computation refresh rate.

### CROSS REFERENCE TO RELATED APPLICATION

This application claims priority of European Patent Application No. EP22306886.7, filed 15 Dec. 2022, which is incorporated herein by reference in its entirety.

### BACKGROUND

In an Augmented Reality (AR) experience, computer-generated virtual elements are inserted in the user real environment using various equipment such as optical see-through glasses or video see-through devices (e.g. smartphone, tablet, headset).

Therefore, information regarding the user environment is useful for a seamless spatial composition of virtual and real objects. Such environment information can allow for features such as: a stable pose of the inserted virtual objects relying on the localization and the tracking of some natural features of the user environment; a proper collision handling as for instance virtual balls rolling on a real table and falling to the floor; and a coherent rendering by considering occlusion and lighting.

Information about the user environment may be achieved using dedicated real-time computation modules such as Google's ARCore, Apple's ARKit environmental understanding, or Microsoft's spatial mapping and scene understanding modules. They rely on the real-time outputs of the embedded device sensors such as depth or color cameras and an inertial measurement unit (IMU) for the user pose estimation.

### SUMMARY

Example embodiments provide a mechanism enabling a user equipment (UE) to adapt the environment-computation refresh rate to improve user XR experience and limit resource usage. In some embodiments, one or more of the following parameters are provided by an XR content creator to each user equipment sharing an AR experience at the beginning of the related XR session: a nominal (or maximum) and a minimum value of the environment-computation refresh rate; a reference to action(s) to be executed in the case where the minimum refresh rate cannot be achieved; a reference to a scanned and/or semantic representation of the real environment; a parameter indicating if the scanned and/or semantic representation shall be used for localization only (baseline), collision handling and/or advanced rendering. Some embodiments include an adaptive runtime update of the environment-computation refresh rate managed by the UE based on a control mechanism.

A method according to some embodiments comprises, at an augmented reality user equipment: obtaining sensor data describing a user's environment; obtaining information indicating at least one factor from among: user movement information, environment evolution information, network condition information, or battery life information; determining a candidate environment-computation refresh rate based on the at least one factor; selecting an environment-computation refresh rate as a minimum of: the candidate environment-computation refresh rate and a maximum environment-computation refresh rate; and updating a real-environment computation using the selected environment-computation refresh rate.

An apparatus according to some embodiments comprises one or more processors configured to perform at least: obtaining sensor data describing a user's environment; obtaining information indicating at least one factor from among: user movement information, environment evolution information, network condition information, or battery life information; determining a candidate environment-computation refresh rate based on the at least one factor; selecting an environment-computation refresh rate as a minimum of: the candidate environment-computation refresh rate and a maximum environment-computation refresh rate; and updating a real-environment computation using the selected environment-computation refresh rate.

Some embodiments of the method or apparatus further comprise obtaining scene description data describing an extended reality scene, and presenting the scene in the user's environment.

Some embodiments of the method or apparatus further comprise receiving metadata indicating the maximum environment-computation refresh rate.

In some embodiments of the method or apparatus, the selection of the environment-computation refresh rate is made on a periodic basis.

In some embodiments of the method or apparatus, the candidate environment-computation refresh rate is determined using a weighted sum of parameters representing at least two of the factors from among: user movement, environment evolution, network conditions, or battery life.

Some embodiments of the method or apparatus further comprise receiving metadata indicating weights used in the weighted sum.

In some embodiments of the method or apparatus, the candidate environment-computation refresh rate is determined based at least on the user movement information and the environment evolution information.

Some embodiments of the method or apparatus further comprise obtaining metadata indicating the maximum environment-computation refresh rate.

Some embodiments of the method or apparatus further comprise determining the maximum environment-computation refresh rate based at least in part on the network condition information.

In some embodiments of the method or apparatus, the candidate environment-computation refresh rate is determined based at least in part on at least one of: the user movement information, the environment evolution information, or the network condition information.

Some embodiments of the method or apparatus further comprise: obtaining information indicating a threshold environment-computation refresh rate and a specified action; and in response to a determination that the selected environment-computation refresh rate is less than the threshold environment-computation refresh rate, performing the specified action.

In some embodiments of the method or apparatus, the candidate environment-computation refresh rate is calculated based at least in part on metadata received in at least one of: a scene description file or a manifest file.

A method according to some embodiments comprises: providing scene description data for an extended reality experience, wherein the scene description data includes at least one of: information indicating a threshold value of an environment-computation refresh rate, information indicating a maximum value of the environment-computation refresh rate, and information indicating at least one specified action to be performed in response to the environment-computation refresh rate falling below the threshold value.

An apparatus according to some embodiments comprises one or more processors configured to perform at least: providing scene description data for an extended reality experience, wherein the scene description data includes at least one of: information indicating a threshold value of an environment-computation refresh rate, information indicating a maximum value of the environment-computation refresh rate, and information indicating at least one specified action to be performed in response to the environment-computation refresh rate falling below the threshold value.

In some embodiments of the method or apparatus, the scene description data further includes at least one weight value for use in calculating the environment-computation refresh rate.

In some embodiments of the method or apparatus, the scene description data further includes, for the at least one weight value, information identifying a factor associated with the respective weight value.

In some embodiments of the method or apparatus, the factor comprises at least one of: user movement information, environment evolution information, network condition information, or battery life information.

Example embodiments further include an apparatus comprising one or more processors configured to perform any of the methods described herein.

Example embodiments further include a computer-readable medium including instructions for causing one or more processors to perform any of the methods described herein.

The computer-readable medium may be a non-transitory storage medium.

Example embodiments further include a computer program product including instructions which, when the program is executed by one or more processors, causes the one or more processors to carry out any of the methods described herein.

A signal according to some embodiments comprises scene description data for a 3D scene including elements as described above.

A computer-readable medium according to some embodiments comprises scene description data for a 3D scene including elements as described above.

### BRIEF DESCRIPTION OF THE DRAWINGS

FIG. 1A is a cross-sectional schematic view of a waveguide display that may be used with augmented reality applications according to some embodiments.

FIGS. 1B-1C are cross-sectional schematic views alternative display types that may be used with augmented reality applications according to some embodiments.

FIG. 1D is a functional block diagram of a system used in some embodiments described herein.

FIG. 2 is a schematic illustration of an example of spatial mapping and scene understanding computation modules.

FIG. 3 is a flow diagram illustrating an initialization process according to some embodiments.

FIG. 4 is a flow diagram illustrating a refresh rate update process according to some embodiments.

FIG. 5 is a flow diagram illustrating a method of determining an updated refresh rate according to some embodiments.

FIG. 6 is a flow diagram illustrating a method of determining an updated refresh rate according to some embodiments.

FIG. 7 is a flow diagram illustrating a method of determining an updated refresh rate according to some embodiments.

FIG. 8 is a flow diagram illustrating a method of determining an updated refresh rate according to some embodiments.

### DETAILED DESCRIPTION

### Augmented Reality (AR) Display Devices.

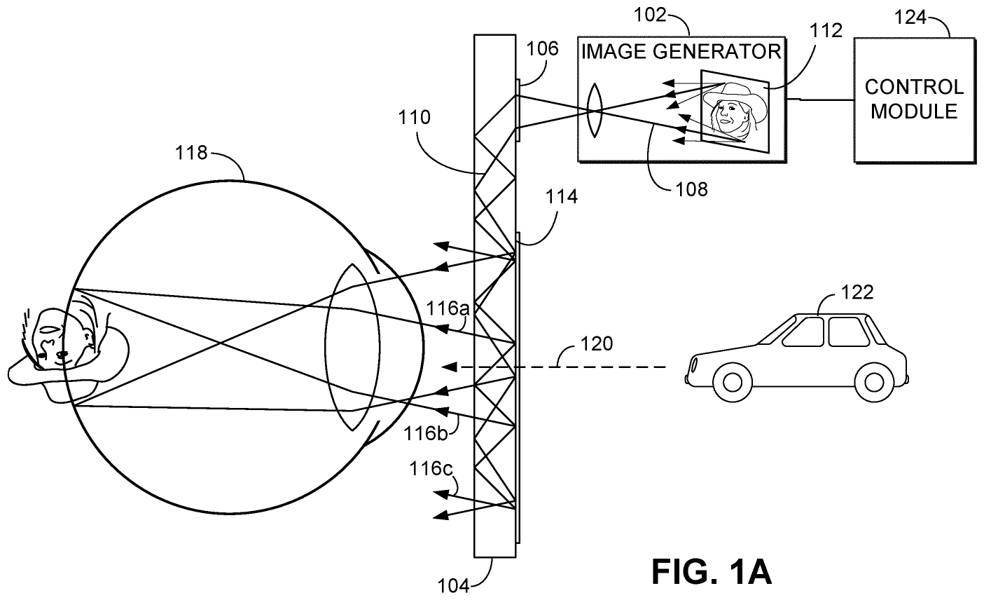

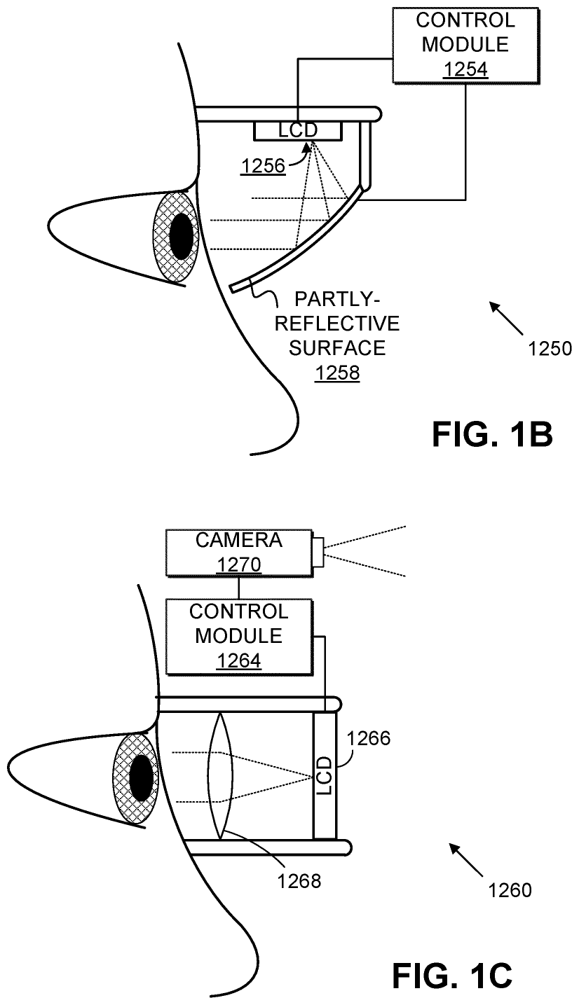

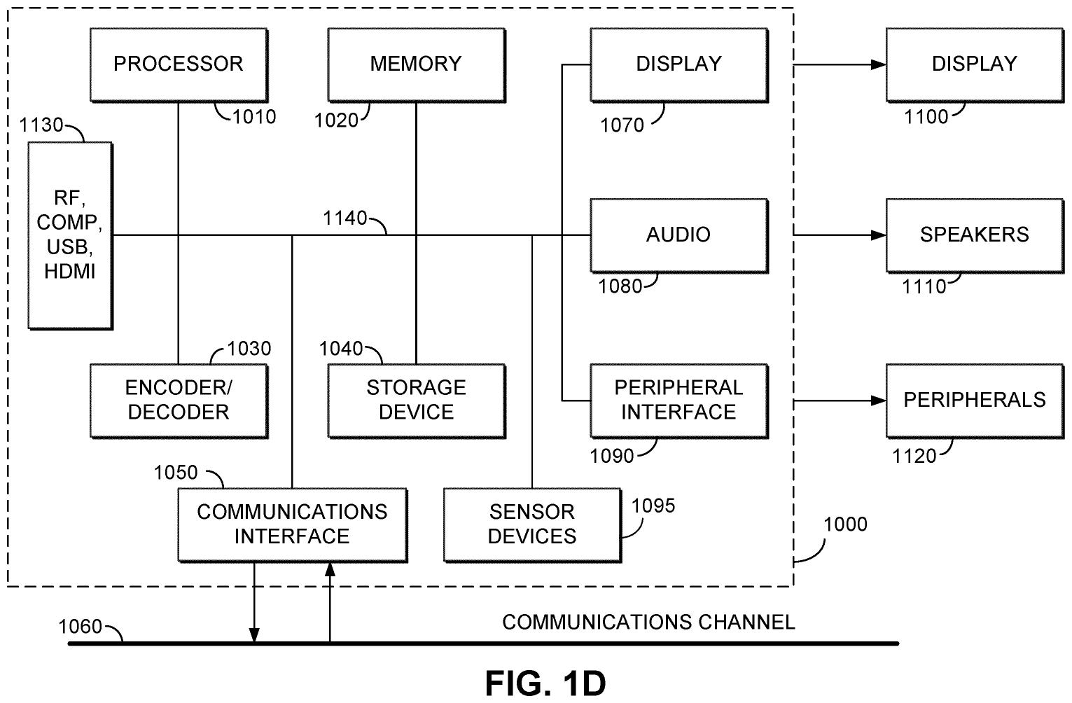

An example augmented reality (AR) display device is illustrated in FIG. 1A. In the present disclosure, augmented reality is also referred to as extended reality (XR). FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B schematically illustrates an alternative type of augmented reality head-mounted display that may be used in some embodiments. In an augmented reality head-mounted display device 1250, a control module 1254 controls a display 1256, which may be an LCD, to display an image. The head-mounted display includes a partly-reflective surface 1258 that reflects (and in some embodiments, both reflects and focuses) the image displayed on the LCD to make the image visible to the user. The partly-reflective surface 1258 also allows the passage of at least some exterior light, permitting the user to see their surroundings.

FIG. 1C schematically illustrates an alternative type of augmented reality head-mounted display that may be used in some embodiments. In a head-mounted display device 1260, a control module 1264 controls a display 1266, which may be an LCD, to display an image. The image is focused by one or more lenses of display optics 1268 to make the image visible to the user. In the example of FIG. 1C, exterior light does not reach the user's eyes directly. However, in some such embodiments, an exterior camera 1270 may be used to capture images of the exterior environment and display such images on the display 1266 together with any virtual content that may also be displayed.

The embodiments described herein are not limited to any particular type or structure of an AR display device.

An augmented reality display device, together with its control electronics, may be implemented using a system such as the system of FIG. 1D. FIG. 1D is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed or otherwise provided to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The system 1000 may include one or more sensor devices 1095. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 1000 is used as the control module for an augmented reality display (such as control modules 124, 1254), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### Overview of Scene Understanding Modules.

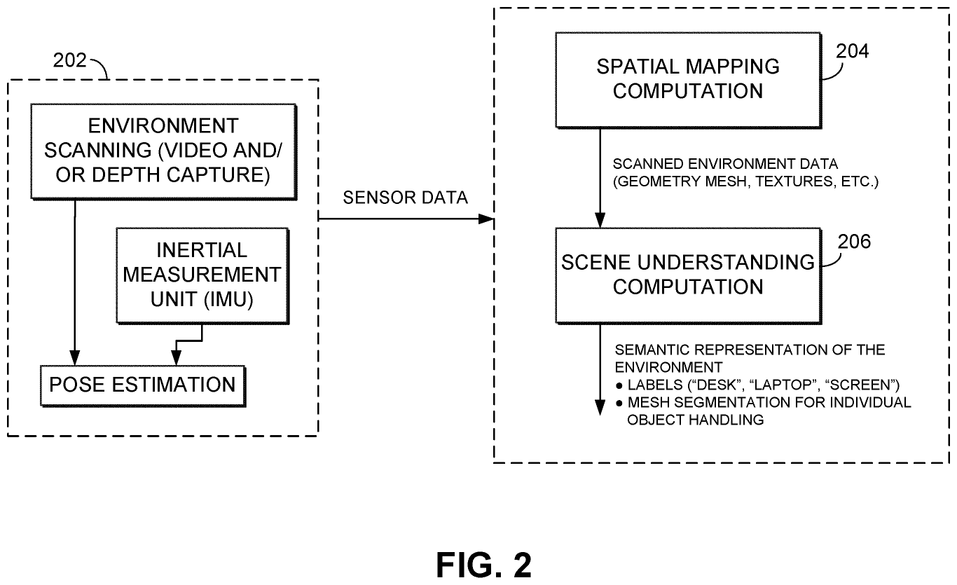

FIG. 2 schematically illustrates the relationship among sensor data, the refresh rate, the spatial mapping, and the scene understanding computation modules. Based on the various sensor data collected by module or modules 202, the real environment can be analyzed through the two following computation modules. A spatial mapping computation module 204 calculates a scanned representation of the real environment. The scanned representation data may include information such as a unique mesh, which may be a set of connected primitives (triangles, quads) related to the geometry of the environment, and color textures. A scene understanding computation module 206 operates to segment the environment into individual semantic elements (e.g. with labels such as “desk”, “laptop”, “screen” and the like).

In some cases, depending on the AR experience to be presented, the presence or the activation of both the computation modules are not necessary. For instance, a spatial mapping computation is not necessary if only a semantic environment representation composed of a set of labels is used. And a scene understanding computation is not required if only a collision handling between real and virtual objects is used.

Both spatial mapping and scene understanding computations may be used if it is intended for the application to handle geometries of individual real objects (e.g. object removing for diminished AR experience).

Example embodiments relate to the adaptive selection and/or control of an environment-computation refresh rate that may be used by either or both of the spatial mapping computation or the scene understanding computation.

A conventional approach relies on a real-time computation of the real environment on the device of each user sharing a common AR experience. However, even if this approach provides an efficient knowledge of each user environment, it suffers from a lack of control of the environment-computation refresh rate from the extended reality (XR) content creator point of view.

### Overview of Example Embodiments

Example embodiments allow for an XR content creator, based on context- and application-specific criteria, to provide metadata that enables the user equipment (UE) to adapt the environment-computation refresh rate to improve user experience and limit resource usage. The context and application-specific criteria may change during the AR/XR experience. These criteria may include one or more of the following:
A static or a dynamic (e.g. time-evolving) real environment.
A static or moving user. The classification of a user as static or moving may change over time, as may the amount of user movement, as a user may explore the environment and may discover new parts of his real environment previously not visible.
The user device state and/or evolution (e.g. battery life threshold, operation in different connectivity and power saving modes such as idle, inactive or connected modes, available CPU cycles, and/or available memory).
The network state and/or evolution (such as traffic load conditions in uplink (UL) and/or downlink (DL), radio link conditions) in the case where part(s) of the computation are delegated to the edge computing devices. Some thresholds on latency, round-trip-time (RTT) and/or packet error rate may be defined.
The usage of the user environment representation at runtime (e.g. localization and tracking only, advanced rendering with occlusion and lighting, collision handling with physics simulation).

For instance, for a static user environment, it may be more efficient for the XR content creator to provide a scanned and/or semantic representation of the environment prior to the runtime AR experience to avoid unnecessary redundant scene understanding computation.

Even for a time-evolving user environment, an initial scanned and/or semantic representation may be updated based on pre-defined refresh rate/profiles or based on runtime analysis relying on some prediction/change detection algorithms.

The XR metadata according to some embodiments may define a nominal (or maximum) value of the environment-computation refresh rate based on one or more of the following.
Tolerable inaccuracies for that AR experience (e.g. accuracy on the spatial positioning of virtual objects).
The usage of the environment representation at runtime. For instance, a collision-only usage would support a different refresh rate compared to a rendering usage.

The XR metadata provided in some embodiments may also allow or prevent a degraded operating mode based on the definition of an additional minimum value of the environment-computation refresh rate in the case of poor user device capabilities and low battery state. Additional network-related conditions (such as congestion or high packet error rate) may also switch to this degraded operating mode in the case where part(s) of the real-environment computation are delegated to the network edge.

The XR metadata in some embodiments may also define one or more actions to be performed by the user equipment in the case where the supported environment-computation refresh rate falls below the minimum refresh rate value. Examples of such actions include displaying a warning message, a progressive fading of the virtual objects, and/or deactivating one or more pre-defined virtual objects (which may be identified in the configuration information) before stopping the rendering of the virtual objects. In some embodiments, these actions provide a temporary and graceful transition from the XR experience to stopping the rendering of the virtual objects, such that rendering of the XR objects is not stopped in a way that is disorienting to a user.

Example embodiments provide a mechanism enabling a user equipment (UE) to adapt the environment-computation refresh rate to improve user XR experience and limit resource usage. This mechanism may use metadata provided by an XR content creator related to context- and application-specific criteria.

In some embodiments, one or more of the following parameters are provided in metadata to a user equipment providing an AR experience to a user, or to each user equipment providing a shared AR experience to multiple users:
A nominal (or maximum) and a minimum value of the environment-computation refresh rate.
A reference to action(s) to be executed in the case where the minimum refresh rate cannot be achieved before stopping the virtual object rendering.
A reference to a scanned and/or semantic representation of the real environment if available at the beginning of the AR experience.
A parameter indicating if the scanned and/or semantic representation shall be used for localization only (baseline), collision handling and/or advanced rendering (e.g. any or all of occlusion, coherent real/virtual lighting, object removal).

Some embodiments include an initialization in which the application running on the UE retrieves the parameters provided as metadata by the XR content creator to configure the control mechanism of the environment-computation refresh rate. The initialization may be performed at the beginning of an AR session, for example.

Some embodiments include runtime updates of the environment-computation refresh rate managed by the UE based on a control mechanism as described herein. Runtime updates may be based on parameters and/or metadata received by the UE at the beginning of the AR session, based on updated parameters received by the UE during the session, or based on a combination of these.

### Initialization.

In some embodiments, an XR scene description file is used to store the control parameters of the environment-computation refresh rate mechanism. The scene description file may describe and provide a reference to all the assets composing this AR experience, and it may also provide other control parameters from the XR content creator related to, for example, user navigation, interactivity, and AR anchoring. The XR scene description file may be used as the entry point for each client/user joining an XR session.

For the sake of the present description, the initialization is detailed here in the scope of the MPEG-I Scene Description framework using the Khronos gITF extension mechanism to support additional scene description features. However, the present principles may alternatively be used with other existing or future descriptions of XR scenes.

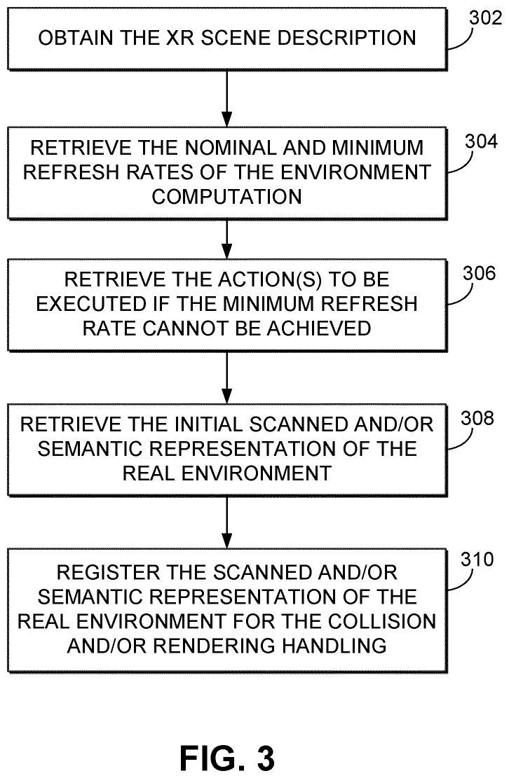

FIG. 3 illustrates an initialization process according to some embodiments. In the example of FIG. 3, the XR scene description is obtained at 302. Information indicating the nominal (or maximum) and minimum refresh rates of the environment computation is retrieved at 304. Such information may be retrieved from the XR scene description. At 306, information is retrieved, e.g. from the XR scene description, indicating which action or actions are to be executed if the minimum refresh rate cannot be achieved. Not all embodiments necessarily include the use of such information. At 308, an initial scanned and/or semantic representation of the real environment is retrieved, e.g. using sensor data. At 310, the scanned and/or semantic representation of the real environment is registered for the handling of rendering and/or collisions.

The control parameters obtained through the initialization may be added to the scene description using an extension either at the gITF scene or node level. Example embodiments are not limited to the use of a scene description file to provide metadata. For example, in some embodiments metadata may be provided in a manifest file (e.g. a DASH manifest file) or through other techniques.

In some embodiments, a MPEG_scene_real_environment gITF scene extension is defined with the parameters depicted in Table 1, below.

TABLE 1
Control parameters provided in a gITF scene extension.

```
{
  ″extensionsUsed″ [
      ″MPEG_scene_interactivity″,
      ″MPEG_scene_real_environment″,
      ...
  ],
  ″scene″: 0,
  ″scenes″: [
      {
        ″extensions″: {
            ″MPEG_scene_interactivity″: {
                ″actions″: [
                      {
                        ″type″: ACTIVATE
                        ...
                      },
                      {
                        ″type″: ANIMATE
                        ...
                      },
                      ...
                  ],
            ...
          },
          ″MPEG_scene_real_environment″: {
                ″nominalRefreshRate″: 60,
                ″minimumRefreshRate″: 20,
                ″actions″: [0, 1],
              ″realNodes″: [0],
              ″envDataTargets″: [COLLISION, RENDERING] },
            },
          ″name″: ″Scene″,
          ″nodes″: [0, 1]
  ],
  ″nodes″: [
      {
            ″name″: ″Scanned node″,
            ″mesh″: 0,
            “matrix″: [1,0,0,0,
                      0,0,−1,0,
                      0,1,0,0,
                      −16.2,−5.5,44.8,1
                    ]
      },
      {
            ″name″: ″Virtual node″,
            ″mesh″: 1,
            “matrix″: [1,0,0,0,
                      0,0,−1,0,
                      0,1,0,0,
                      15,5,−18,1
                    ]
    },
      ...
  ]
  ...
}
```

In the example of Table 1, the nominal and minimum refresh rate parameters are given values of 60 and 20 frames per second, respectively. If the XR content creator does not want to define a degraded operating mode, the nominal and the minimum refresh rates may be given the same value, or the minimum refresh rate may be excluded.

A parameter such as the “actions” parameter above may be used to provide a reference to the action or actions to be executed if the minimum refresh rate cannot be achieved during the runtime update. It may be an empty array if the XR content creator does not want to define these actions. In this example, the two first actions defined in the action array of the MPEG_scene_interactivity extension are referenced. The first action in this example is an ACTIVATE action that may be used for activating the display of a warning message. The second action in this example is an ANIMATE action that may be used for animating the alpha/transparency channel of the color of the virtual objects for fading purposes.

A parameter such as the realNodes parameter of Table 1 may be used to reference the node or nodes of the gITF nodes array containing the initial scanned and/or semantic environment data if available. In the example of Table 1, the environment data are provided in the first node of the gITF nodes array.

A parameter such as the envDataTargets parameter of Table 1 may be provided to indicate whether the environment data used for the pose of virtual objects shall also additionally be used for the collision handling and/or for advanced rendering. In this example, the environment representation is to be used both for collision handling and for advanced rendering (e.g. for occlusion, coherent lighting).

In another example embodiment, shown in Table 2, below, the control parameters are provided in a MPEG_node_real_environment gITF node extension. In this embodiment, the realNodes parameter is not used because the extension is added directly to the corresponding glTF node(s).

TABLE 2
Control parameters provided in a gITF node extension.

```
{
  ″extensionsUsed″ [
      ″MPEG_scene_interactivity″,
      ″MPEG_node_real_environment″,
      ...
  ],
  ″scene″: 0,
  ″scenes″: [
      {
        ″extensions″: {
            ″MPEG_scene_interactivity″: {
                ″actions″: [
                      {
                        ″type″: ACTIVATE
                        ...
                      },
                      {
                        ″type″: ANIMATE
                        ...
                      },
                      ...
                  ],
            ...
          },
          ″name″: ″Scene″,
          ″nodes″: [0, 1]
  ],
  ″nodes″: [
      {
        extensions {
            ″MPEG_node_real_environment″: {
                ″nominalRefreshRate″: 60,
                ″minimumRefreshRate″: 20,
                ″actions″: [0, 1],
              ″envDataTargets″: [COLLISION, RENDERING] },
            }
  }
            ″name″: ″Scanned node″,
            ″mesh″: 0,
            “matrix″: [1,0,0,0,
                      0,0,−1,0,
                      0,1,0,0,
                      −16.2,−5.5,44.8,1
                    ]
      },
      {
            ″name″: ″Virtual node″,
            ″mesh″: 1,
            “matrix″: [1,0,0,0,
                      0,0,−1,0,
                      0,1,0,0,
                      15,5,−18,1
                    ]
    },
      ...
  ]
  ...
}
```

### Refresh Rate Update.

In applications that make use of a known static real environment, where a scanned and/or semantic representation is already available, there is no need to compute the real environment at runtime. In that case, the XR content creator may set the nominal refresh rate to zero and provide the initial (and hence permanent) environment representation in the XR scene description file.

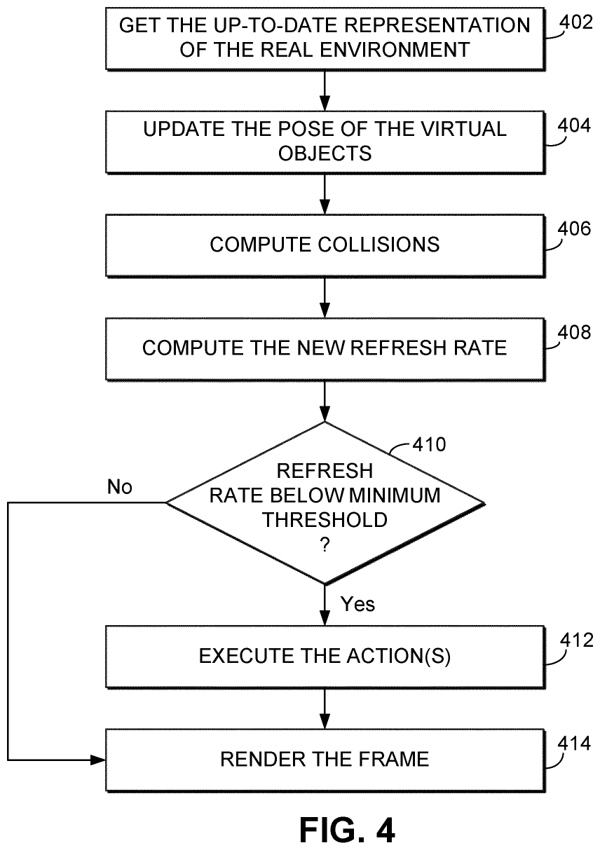

FIG. 4 illustrates a method performed to provide a per-frame update of the environment-computation refresh rate according to some embodiments. In some embodiments, a method as shown in FIG. 4 may be performed before the rendering of each frame. At 402, an up-to-date representation of the real environment is obtained. At 404, the pose of virtual objects in the scene is updated. At 406, collisions in the scene are computed. At 408, a new environment refresh rate is computed. At 410, a determination is made of whether the new environment refresh rate is below a minimum threshold. If so a defined action may be performed at 412, such as the display of a warning message. At 414, the frame is rendered.

The rendering of the 3D scene is performed by a rendering module which may be located in the user equipment (UE) or implemented in an edge computing device in the case of a split rendering architecture.

Before rendering a frame, the rendering module gets the up-to-date scanned and/or semantic representation of the real environment, computed at a refresh rate determined during the previous frame.

The embedded-sensor data are fetched by the user equipment (UE). Then the up-to-date environment representation is either computed in the UE or using edge computing depending on the UE computing capabilities. This environment representation is then used to perform one or more of the following: update the pose of the virtual objects within the real environment; compute the collision between virtual and real objects if the collision mode has been defined as a envDataTargets in the XR scene description; and render the frame with advanced rendering features (e.g. occlusion handling, coherent lighting between real and virtual objects, object removal, and possibly other features which promote realistic rendering and scene interaction) if the rendering mode has been defined as a envDataTargets in the XR scene description.

The timing of the determination of the new value of the environment-computation refresh rate may be different in different embodiments. For example, it may be done on a per-frame basis, periodically every N frames or on-demand/triggered by the application. The application may rely on the previous refresh rate values to determine when a new value is to be calculated. For instance, if the refresh rate value is quite stable over a period, the application may make a determination to skip the computation for that frame or to compute every N frames (where N may be a preset number). In the contrary case, when the refresh rate value is changing rapidly, the application may make a determination to accelerate the computation up to a per-frame basis.

In some embodiments, the computation of the new value of environment-computation refresh rate may be based at least in part on the prediction of the user movement velocity based on the extrapolation of previous values. For example, the amount of user movement may vary as the user may discover new parts of the real environment previously not visible. The refresh rate may be increased in response to a determination that faster user movements are extrapolated, and it may be decreased in response to a determination that slower user movements are extrapolated.

In some embodiments, the computation of the new value of environment-computation refresh rate may be based at least in part on the prediction of the real-environment modification velocity based on the extrapolation of previous values. The refresh rate may be increased in response to a determination that faster real-environment modifications are extrapolated, and it may be decreased in response to a determination that slower real-environment modifications are extrapolated.

In some embodiments, the computation of the new value of environment-computation refresh rate may be based at least in part on the user device state evolution, such as the battery life. The refresh rate may be set to the defined minimum refresh rate in response to a determination that the battery life has fallen below a threshold (e.g. 10%), which may be an application-defined threshold.

In some embodiments, the computation of the new value of environment-computation refresh rate may be based at least in part on the network state evolution, such as radio link conditions or traffic load conditions in uplink (UL) and/or downlink (DL), in the case where part(s) of the computation are delegated to edge computing. The refresh rate may be increased in response to a determination that better network characteristics are extrapolated from traffic measurements, and it may be decreased in response to a determination that worse network characteristics are extrapolated from traffic measurements.

In some embodiments, a consolidated new refresh rate value may result from a weighted sum or other combination of two or more of the above effects. In some embodiments, the battery life factor overrides other conditions, such that low battery life results in the use of a minimum refresh rate regardless of the other conditions. In some embodiments, the nominal refresh rate is used as a maximum refresh rate. For example, if the consolidated new refresh rate value is above the nominal refresh rate, then the user equipment uses the nominal refresh rate.

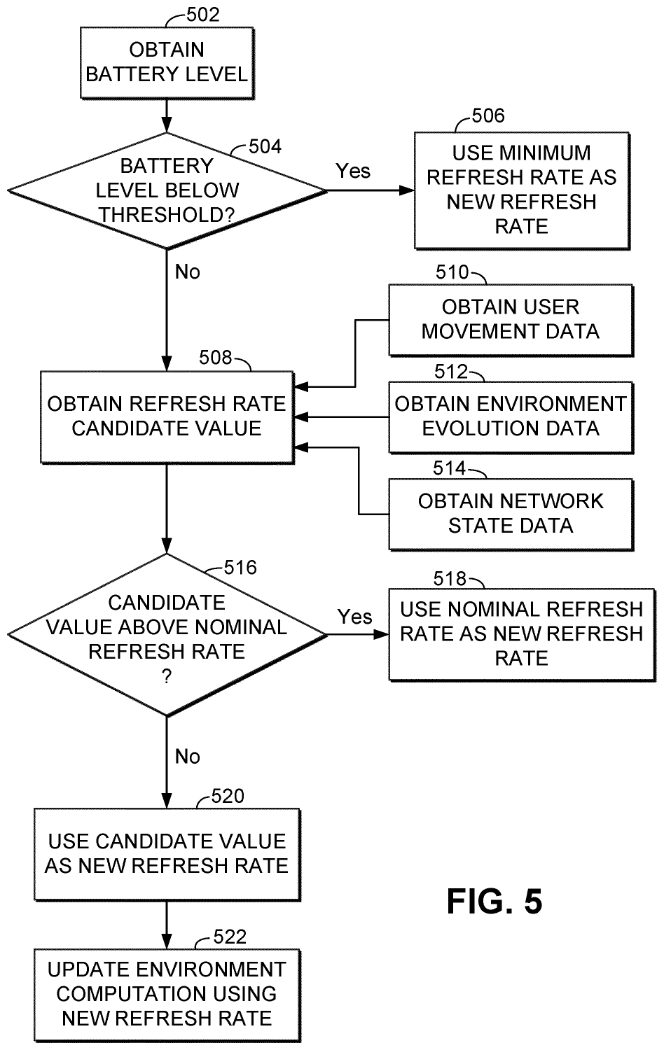

FIG. 5 is a flow diagram illustrating a method of determining an updated refresh rate according to some embodiments. In the following description, a current refresh rate is referred to as Rate (n) and a subsequent refresh rate is referred to as Rate (n+1).

As shown in FIG. 5, information about a user equipment battery level is obtained at 502. If the battery level is below a threshold (which may be a predetermined threshold), as determined at 504, the subsequent refresh rate Rate (n+1) is set at 506 to be equal to a minimum refresh rate (which may have been signaled to user equipment using the parameter minimumRefreshRate). If the battery level is not below the threshold, a new candidate refresh rate is obtained at 508. The candidate refresh rate may be obtained based on one or more environmental or other factors such as user movement data (obtained at 510), environment evolution data (obtained at 512), or network state data (obtained at 514).

In some embodiments, a candidate rate value NewRate is calculated using a weighted sum as follows.

$$NewRate = Rate ( n ) + ( {w}_{1} \cdot {Δ}_{user} + w 2 \cdot {Δ}_{environment} + {w}_{3} \cdot {Δ}_{network} ) / ( {w}_{1} + {w}_{2} + {w}_{3} )$$

where Δᵤₛₑᵣ is the variation of the refresh rate from the user movement (negative value if the user movement becomes slower), Δₑₙᵥᵢᵣₒₙₘₑₙₜ is the variation of the refresh rate from the environment evolution (negative value if the environment evolution becomes slower), and Δ_{network} is the variation of the refresh rate depending on the network state evolution (negative value if the network state evolution becomes worse). In this and other embodiments using weights such as w₁, w₂ and w₃, some or all of the weights may be defined in a configuration file, signaled to to the user equipment in the scene description data or through other means (e.g. in a manifest file), or otherwise selected to control the effect of these different evolutions on the calculation of the refresh rate. For instance, the user movements may be more or less critical in one particular AR experience. In some embodiments, some weights are provided to the user equipment (for example in the scene description data) while other weights are determined locally at the user equipment. For example, weights relating more closely to the AR experience, such as weights relating to the effect of user movement or environment evolution on the refresh rate, may be provided in the scene description data, while weights relating to the operation or state of the user equipment, such as weights relating to network conditions, battery life, available CPU cycles, and/or available memory may be selected locally. In some embodiments, the refresh rate at the start of the AR experience, which may be referred to as Rate(0), is set equal to a nominal refresh rate, such as the parameter nominalRefreshRate. In other embodiments, different values are selected for Rate(0).

In some embodiments, the delta values such as Δᵤₛₑᵣ, Δₑₙᵥᵢᵣₒₙₘₑₙₜ, Δ_{network} and the like represent a change from the evolution of the user movements, user environment, network conditions, or other relevant parameters. The delta values may be proportional to the derivative of an evolution (e.g. proportional to an acceleration). The delta values from user and/or environment evolution may be calculated using extrapolation from previous measured values. For example, the previous poses of the user may be used to determine the evolution and the acceleration of the user movements. The delta value may then be proportional to this acceleration. For the delta relating to evolution of the environment, the user equipment may rely on a similar approach. The user equipment may store the previous poses of each relevant/main real objects of the user environment to determine the evolution and the acceleration of the real objects.

In some embodiments, if the candidate rate NewRate is greater than a nominal refresh rate (which may have been signaled to the user equipment using the parameter nominalRefreshRate), as determined at 516, the nominal rate is used at 518 as the subsequent refresh rate Rate (n+1). In this and similar embodiments the nominal refresh rate is used as a maximum refresh rate. If the candidate rate NewRate is less than the nominal refresh rate, then the candidate rate NewRate is used at 520 as the subsequent refresh rate Rate (n+1). Specifically, the rate Rate (n+1) may be selected as follows:

$$Rate ( n + 1 ) = minimum of \{ nominalRefreshRate , Rate ( n ) + ( {w}_{1} \cdot {Δ}_{user} + {w}_{2} \cdot {Δ}_{environment} + {w}_{3} \cdot {Δ}_{network} ) / ( {w}_{1} + {w}_{2} + {w}_{3} ) \}$$

At 522, the environment computation is updated using the new refresh rate. The updating of the environment computation may include the updating of a spatial mapping of the environment, such as one or more of the following types of data representing the user's environment: point cloud data, geometry mesh data, mesh segmentation information, texture data, and/or semantic labeling, among other types of data representing the environment.

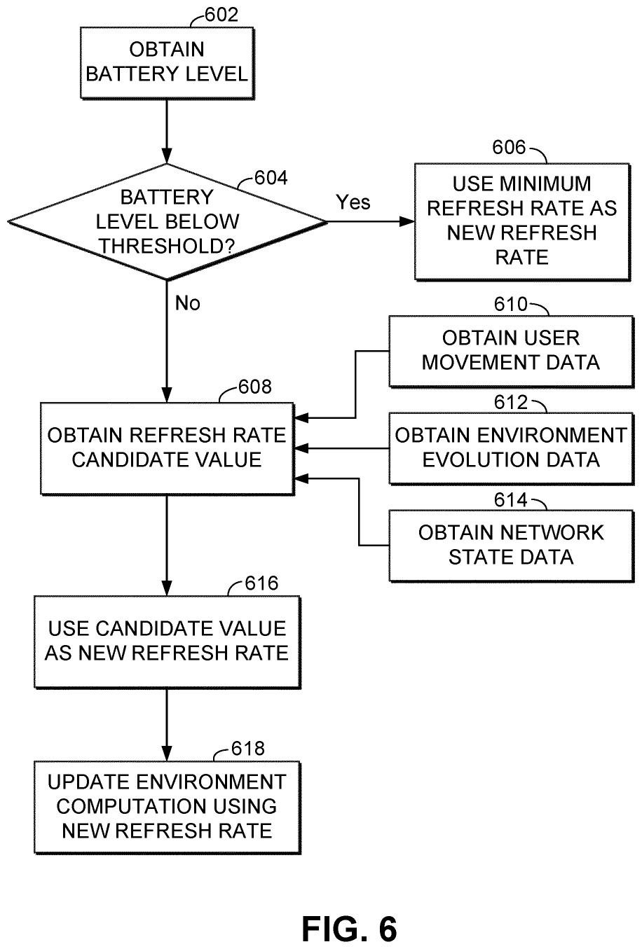

In some embodiments, such as the embodiment of FIG. 6, the refresh rate may be updated as follows. The battery level is obtained at 602. If a determination is made at 604 that the battery level is below a threshold (which may be a predetermined threshold or a threshold signaled in the scene description data), the subsequent refresh rate Rate (n+1) is set at 606 to be equal to a minimum refresh rate (which may have been signaled to the user equipment using the parameter minimumRefreshRate). If the battery level is not below the threshold, a new candidate refresh rate NewRate is obtained at 608 using some or all of the following: user movement data obtained at 610, environment evolution data obtained at 612, and network state data obtained at 614. In some embodiments, the new candidate refresh rate may be calculated using a weighted sum as follows.

$$New Rate = nominalRefreshRate + ( {w}_{1} \cdot {Δ}_{user} + w 2 \cdot {Δ}_{environment} + {w}_{3} \cdot {Δ}_{netowrk} ) / ( {w}_{1} + {w}_{2} + {w}_{3} )$$

In some such embodiments, the updated rate Rate (n+1) may be set equal to NewRate at 606 even if NewRate is above nominalRefreshRate.

At 618, the environment computation is updated using the new refresh rate. The updating of the environment computation may include the updating of a spatial mapping of the environment, such as one or more of the following types of data representing the user's environment: point cloud data, geometry mesh data, mesh segmentation information, texture data, and/or semantic labeling, among other types of data representing the environment.

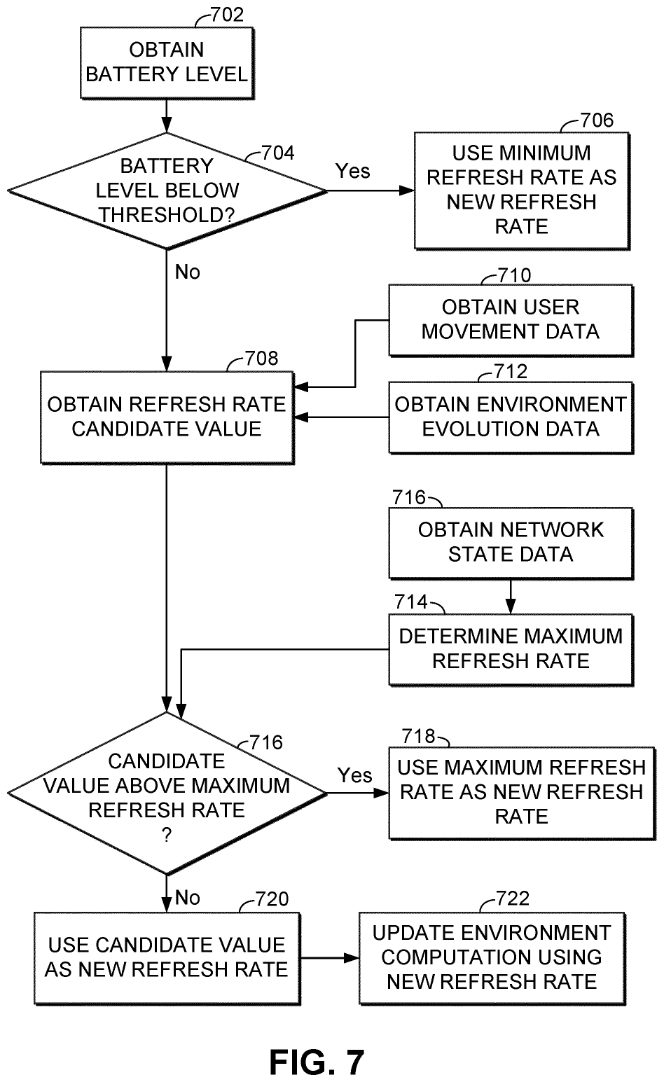

In some embodiments, such as the embodiment of FIG. 7, a maximum refresh rate value R_{network} is imposed based on network bandwidth availability. In such an embodiment, the refresh rate may be updated as follows. A current battery level is obtained at 702, and a determination is made at 704 of whether the battery level is below a threshold. If the battery level is below the threshold (which may be a predetermined threshold or a signaled threshold), the subsequent refresh rate Rate (n+1) is set at 706 to be equal to a minimum refresh rate (which may have been signaled to the user equipment using the parameter minimumRefreshRate). If the battery level is not below the threshold, a candidate refresh rate is obtained at 708 using some or all of the following: user movement data obtained at 710 and environment evolution data obtained at 712.

In some embodiments, the candidate refresh rate may be calculated as follows.

$$nominalRefreshRate + ( {w}_{1} \cdot {Δ}_{user} + w 2 \cdot {Δ}_{environment} ) / ( {w}_{1} + {w}_{2} ) \}$$

A value of R_{network}, used here as a maximum refresh rate, may be determined at 714 as a function of network conditions obtained at 716. In an example embodiment, better network conditions (e.g. high bandwidth, low packet error rate) result in higher values of R_{network} and worse network conditions result in lower values of R_{network}. In response to a determination at 716 that the candidate refresh rate is above the maximum refresh rate, the maximum refresh rate is used at 718 as the new refresh rate. In response to a determination at 716 that the candidate refresh rate is not above the maximum refresh rate, the candidate refresh rate is used at 720 as the new refresh rate. In an embodiment as in FIG. 7, the new refresh rate may be calculated using an equation such as the following.

$$NewRate = minimum of \{ {R}_{network} , nominalRefreshRate + ( {w}_{1} \cdot {Δ}_{user} + w 2 \cdot {Δ}_{environment} ) / ( {w}_{1} + {w}_{2} ) \}$$

At 722, the environment computation is updated using the new refresh rate. The updating of the environment computation may include the updating of a spatial mapping of the environment, such as one or more of the following types of data representing the user's environment: point cloud data, geometry mesh data, mesh segmentation information, texture data, and/or semantic labeling, among other types of data representing the environment.

In some embodiments, the refresh rate may be determined as follows. A maximum refresh rate value R_{network} is imposed based on network bandwidth availability. If the battery level is below a threshold (which may be a predetermined threshold), the subsequent refresh rate Rate (n+1) is set to be equal to a minimum refresh rate (which may have been signaled to the user equipment using the parameter minimumRefreshRate). If the battery level is not below the threshold, a new candidate refresh rate NewRate is obtained using a weighted sum as follows.

$$NewRate = minimum of \{ {R}_{network} , nominalRefreshRate + max \{ {w}_{1} \cdot {Δ}_{user} , w 2 \cdot {Δ}_{environment} \} \}$$

In such an embodiment, instead of using a weighted average of user and environment factors, the refresh rate is updated according to which factor has the highest value.

In some embodiments, the value of R_{network} may be determined as a function of network conditions, with better network conditions (e.g. high bandwidth, low packet error rate) resulting in higher values of R_{network} and worse network conditions resulting in lower values of R_{network}.

In some embodiments, the refresh rate is determined using a technique other than the examples above, such as a technique that does not make use of a weighed sum. In some embodiments, the determination of an updated refresh rate includes adding a difference value to a previous refresh-rate value or a nominal refresh-rate value. In some embodiments, an updated refresh rate is not necessarily determined based on a previous refresh-rate value or a nominal refresh-rate value. The refresh rate may in some embodiments be calculated based on a function or algorithm that returns relatively higher values for greater user movement, greater rate of environment evolution, better network conditions, and/or higher battery life and that returns relatively lower values for less user movement, lower speed of environment evolution, worse network conditions, and/or lower battery life. In some embodiments additional factors representing the state of the user, the user equipment, the environment, the network, the AR content, or other considerations may be used in determining the refresh rate.

In some embodiments, the refresh rate is determined using a target refresh rate and an adaptive maximum refresh rate. The target refresh rate may be a refresh rate that provides a desirable level of AR presentation quality for a given level of movement of the user and/or the environment. As non-exclusive examples, the target refresh rate TargetRate (n+1) may be determined using one of the following formulas or using a different technique:

$$TargetRate ( n + 1 ) = TargetRate ( n ) + ( {w}_{1} \cdot {Δ}_{user} + w 2 \cdot {Δ}_{environment} ) / ( {w}_{1} + {w}_{2} )$$

$$TargetRate ( n + 1 ) = nominalRefreshRate + ( {w}_{1} \cdot {Δ}_{user} + w 2 \cdot {Δ}_{environment} ) / ( {w}_{1} + {w}_{2} )$$

$$TargetRate ( n + 1 ) = nominalRefreshRate + max \{ {w}_{1} \cdot {Δ}_{user} , w 2 \cdot {Δ}_{environment} \}$$

In an example embodiment, the target refresh rate represents a refresh rate that is adequate to provide a good user experience without being unnecessarily high (and thus unnecessarily draining on user equipment resources). For example, if the user is relatively still and their environment is relatively unchanging, it may not be necessary to have a high refresh rate to provide a good AR experience, and it may be desirable to use a lower target refresh rate to conserve resources. However, if the user and/or their environment are in motion, a higher target refresh rate may be desirable to maintain the quality of the AR experience. In some embodiments, the battery level of the user equipment may have an effect on the target refresh rate, with a greater battery life leading to a higher target refresh rate and a lower battery life leading to a lower target refresh rate. In some embodiments, the target rate is selected based in part on a predetermined (e.g. signaled in scene description data) or adaptive minimum rate. For example, the target rate may be selected using one of the following non-limiting examples.

$$TargetRate ( n + 1 ) = maximum of \{ minimumRefreshRate , TargetRate ( n ) + ( {w}_{1} \cdot {Δ}_{user} + w 2 \cdot {Δ}_{environment} ) / ( {w}_{1} + {w}_{2} ) \}$$

$$TargetRate ( n + 1 ) = maximum of \{ minimumRefreshRate , nominalRefreshRate + ( {w}_{1} \cdot {Δ}_{user} + w 2 \cdot {Δ}_{environment} ) / ( {w}_{1} + {w}_{2} ) \}$$

$$TargetRate ( n + 1 ) = maximum of \{ minimumRefreshRate , nominalRefreshRate + max \{ {w}_{1} \cdot {Δ}_{user} , w 2 \cdot {Δ}_{environment} \} \}$$

The minimum rate may be used as the target rate when, for example, the user and their environment are both static.

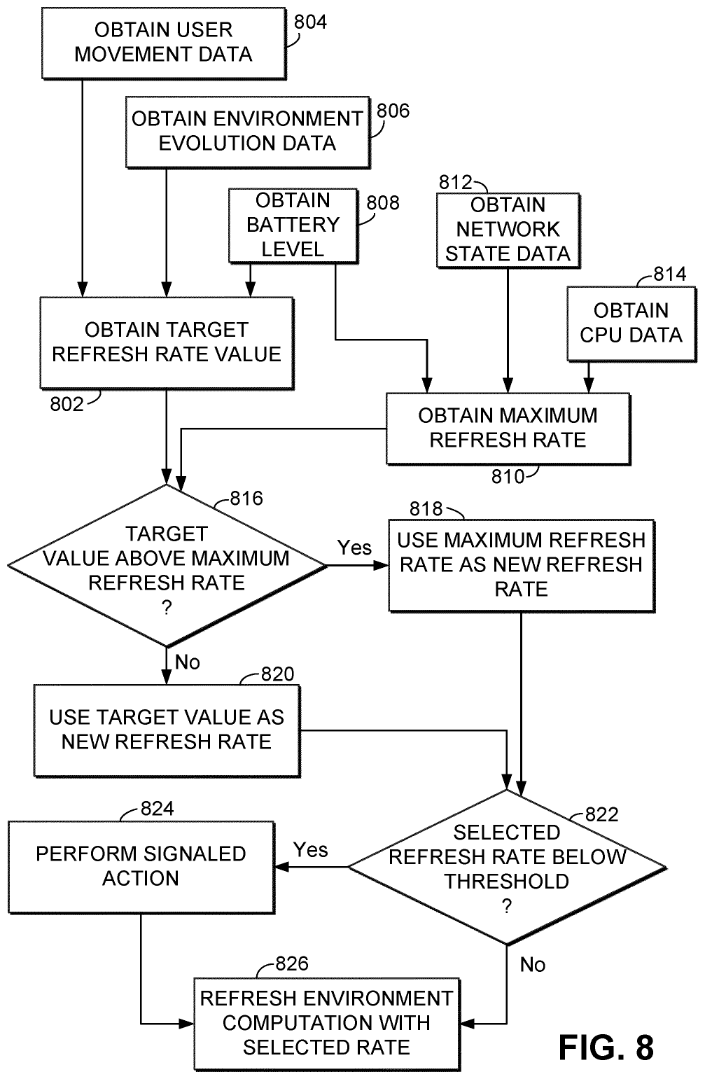

The adaptive maximum refresh rate may represent the highest refresh rate that can feasibly be implemented by the user equipment. The adaptive maximum refresh rate may depend on one or more parameters of the user equipment. For example, greater battery life, greater available CPU cycles, and/or greater available memory may result in a higher adaptive maximum refresh rate, while lower battery life, fewer available CPU cycles, and/or less available memory may result in a lower adaptive maximum refresh rate. The computation of the adaptive maximum refresh rate may in some cases be based on network conditions (e.g. bandwidth, latency, and/or network QoS), e.g. for the case where scene or environment processing is making use of edge or cloud computing resources. The flow chart of FIG. 8 illustrates an example method of selecting an adaptive refresh rate using a target refresh rate and an adaptive maximum refresh rate. Following the principles disclosed herein, the target refresh rate and adaptive maximum refresh rate may be determined using equations other than those specifically given above or determined using techniques other than equations, such as lookup tables.

In the example of FIG. 8, a target refresh rate value is obtained at 802 based on some or all of the following data: user movement data obtained at 804, environment evolution data obtained at 806, battery level data obtained at 808, and/or additional data. A maximum refresh rate value is obtained at 810 based on some or all of the following data: battery level data obtained at 808, network state data obtained at 812, CPU data obtained at 814, and/or additional data. A determination is made at 816 of whether the target refresh rate is above the maximum refresh rate. In response to a determination that the target refresh rate is above the maximum refresh rate, the maximum refresh rate is used at 818 as the new refresh rate. In response to a determination that the target refresh rate is above the maximum refresh rate, the maximum refresh rate is used at 818 as the new refresh rate. In response to a determination that the target refresh rate is not above the maximum refresh rate, the target refresh rate is used at 820 as the new refresh rate.

In some embodiments, a determination is made at 822 of whether the selected new refresh rate is below a threshold (which may be a threshold signaled in the scene description data or elsewhere, or which may be a predefined threshold), the user equipment performs a corresponding action 824 signaled in the scene description data, such as signaling a warning message, progressively fading the virtual objects, and/or deactivating one or more of the virtual objects. In some embodiments, the minimum value that serves as the lower limit on the target refresh rate may be different from the threshold that serves to trigger actions signaled in the scene description data. In other embodiments, they may be the same.

At 826, the environment computation is refreshed according to the selected new refresh rate. The updating of the environment computation may include the updating of a spatial mapping of the environment, such as one or more of the following types of data representing the user's environment: point cloud data, geometry mesh data, mesh segmentation information, texture data, and/or semantic labeling, among other types of data representing the environment.

In some embodiments, one or more of the mentioned factors (or other factors) may be used to set maximum or minimum refresh rates. For example, greater user movement, greater speed of environment evolution, better network conditions, and/or higher battery life may cause a maximum or minimum refresh rate to be set relatively high, while less user movement, lower speed of environment evolution, worse network conditions, and/or lower battery life may cause a maximum or minimum refresh rate to be set relatively low. In some embodiments, the refresh rate may be determined using a lookup table, a linear function, a piecewise linear function, or other analogous technique.

While some of the embodiments described above (e.g. with respect to FIGS. 5-7) set the refresh rate to a minimum value in response to low battery life, it should be noted that each of these embodiments may be implemented without such a feature. In some embodiments, battery life may have no effect on the refresh rate. In some embodiments, battery life may be one factor (possibly among other factors) used to determine the refresh rate.

In a case where the new refresh rate (as determined according to FIG. 5 or through another technique) is below the defined minimum refresh rate, the rendering engine may execute the defined action(s) before rendering the current frame.

### Further Embodiments

A method according to some embodiments comprises: providing scene description data for an augmented reality experience, wherein the scene description data includes at least one of: information indicating a minimum value of an environment-computation refresh rate, information indicating a nominal value of the environment-computation refresh rate, and information indicating at least one action to be performed if an environment-computation refresh rate falls below the minimum value.

In some embodiments, the scene description data further includes at least one of: information indicating whether environment data is used for collision handling, and information indicating whether environment data is used for rendering.

In some embodiments, the scene description data is provided in a scene description file.

A method according to some embodiments comprising, at an augmented reality user equipment: obtaining information indicating a minimum value of an environment-computation refresh rate; determining a battery life of the augmented reality user equipment; in response to a determination that the battery life is below a threshold, setting the environment-computation refresh rate to the minimum value.

A method in some embodiments comprises, at an augmented reality user equipment: obtaining information indicating at least one factor from among: user movement, environment evolution, network conditions, or battery life; and adaptively determining an environment-computation refresh rate based on the at least one factor.

Some embodiments further comprise receiving information indicating a nominal value of the environment-computation refresh rate, wherein the determined environment-computation refresh rate is based at least in part on the nominal value. In some such embodiments, the nominal value is used as a maximum value for the environment-computation refresh rate.

In some embodiments, the environment-computation refresh rate is determined on a periodic basis.

In some embodiments, each environment-computation refresh rate is determined based on a previous environment-computation refresh rate.

Some embodiments further include refreshing a real-environment computation using the determined environment-computation refresh rate.

An apparatus according to some embodiments comprises at least one processor configured to perform: providing scene description data for an augmented reality experience, wherein the scene description data includes at least one of: information indicating a minimum value of an environment-computation refresh rate, information indicating a nominal value of the environment-computation refresh rate, and information indicating at least one action to be performed if an environment-computation refresh rate falls below the minimum value.

In some embodiments, the scene description data further includes at least one of: information indicating whether environment data is used for collision handling, and information indicating whether environment data is used for rendering.

In some embodiments, the scene description data is provided in a scene description file.

An augmented reality user equipment apparatus according to some embodiments comprises at least one processor configured to perform: obtaining information indicating a minimum value of an environment-computation refresh rate; determining a battery life of the augmented reality user equipment; in response to a determination that the battery life is below a threshold, setting the environment-computation refresh rate to the minimum value.

An augmented reality user equipment apparatus according to some embodiments comprises at least one processor configured to perform: obtaining information indicating at least one factor from among: user movement, environment evolution, network conditions, or battery life; adaptively determining an environment-computation refresh rate based on the at least one factor.

Some embodiments further include receiving information indicating a nominal value of the environment-computation refresh rate, wherein the determined environment-computation refresh rate is based at least in part on the nominal value.

Some embodiments further include receiving information indicating a nominal value of the environment-computation refresh rate, wherein the nominal value is used as a maximum value for the environment-computation refresh rate.

In some embodiments, the environment-computation refresh rate is determined on a periodic basis.

In some embodiments, each environment-computation refresh rate is determined on a previous environment-computation refresh rate.

Some embodiments further comprise refreshing a real-environment computation using the determined environment-computation refresh rate.

A method according to some embodiments comprises, at an augmented reality user equipment: obtaining information indicating at least one factor from among: user movement, environment evolution, network conditions, battery level, available CPU cycles, or available memory; adaptively determining a target environment-computation refresh rate based on at least a first one of the factors; adaptively determining a maximum environment-computation refresh rate based on at least a second one of the factors; and setting an environment-computation refresh rate for the user equipment as the minimum of the target environment-computation refresh rate and the maximum refresh rate.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to scene encoding and decoding, and at least one other aspect generally relates to transmitting a bitstream generated or encoded. These and other aspects can be implemented as a method, an apparatus, a computer readable storage medium having stored thereon instructions for encoding or decoding scene data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.

Note that various hardware elements of one or more of the described embodiments may be referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining sensor data describing a user's environment;
obtaining information indicating at least one factor from among: user movement information, environment evolution information, network condition information, or battery life information;
determining a candidate environment-computation refresh rate based on the at least one factor;
selecting an environment-computation refresh rate as a minimum of: the candidate environment-computation refresh rate and a maximum environment-computation refresh rate; and
updating a real-environment computation using the selected environment-computation refresh rate.

2. An apparatus comprising one or more processors configured to perform at least:
obtaining sensor data describing a user's environment;
obtaining information indicating at least one factor from among: user movement information, environment evolution information, network condition information, or battery life information;
determining a candidate environment-computation refresh rate based on the at least one factor;
selecting an environment-computation refresh rate as a minimum of: the candidate environment-computation refresh rate and a maximum environment-computation refresh rate; and
updating a real-environment computation using the selected environment-computation refresh rate.

3. The method of claim 1, further comprising obtaining scene description data describing an extended reality scene, and presenting the scene in the user's environment.

4. The method of claim 1 further comprising receiving metadata indicating the maximum environment-computation refresh rate.

5. The method of claim 1, wherein the selection of the environment-computation refresh rate is made on a periodic basis.

6. The method of claim 1, wherein the candidate environment-computation refresh rate is determined using a weighted sum of parameters representing at least two of the factors from among: user movement, environment evolution, network conditions, or battery life.

7. The method of claim 6, further comprising receiving metadata indicating weights used in the weighted sum.

8. The method of claim 1, wherein the candidate environment-computation refresh rate is determined based at least on the user movement information and the environment evolution information.

9. The method of claim 1, further comprising obtaining metadata indicating the maximum environment-computation refresh rate.

10. The method of claim 1, further comprising determining the maximum environment-computation refresh rate based at least in part on the network condition information.

11. The method of claim 1, wherein the candidate environment-computation refresh rate is determined based at least in part on at least one of: the user movement information, the environment evolution information, or the network condition information.

12. The method of claim 1, further comprising:
obtaining information indicating a threshold environment-computation refresh rate and a specified action; and
in response to a determination that the selected environment-computation refresh rate is less than the threshold environment-computation refresh rate, performing the specified action.

13. The method of claim 1, wherein the candidate environment-computation refresh rate is calculated based at least in part on metadata received in at least one of: a scene description file or a manifest file.

14. A method comprising:
providing scene description data for an extended reality experience, wherein the scene description data includes:
information indicating a threshold value of an environment-computation refresh rate,
information indicating a nominal value of the environment-computation refresh rate, and
information indicating at least one specified action to be performed in response to the environment-computation refresh rate falling below the threshold value.

15. (canceled)

16. The method of claim 14, wherein the scene description data further includes at least one weight value for use in calculating the environment-computation refresh rate.

17. The method of claim 16, wherein the scene description data further includes, for the at least one weight value, information identifying a factor associated with the respective weight value.

18. The method of claim 17, wherein the factor comprises at least one of: user movement information, environment evolution information, network condition information, or battery life information.

19-21. (canceled)

22. The apparatus of claim 2, further comprising obtaining scene description data describing an extended reality scene, and presenting the scene in the user's environment.

23. The apparatus of claim 2, further comprising receiving metadata indicating the maximum environment-computation refresh rate.

24. The apparatus of claim 2, wherein the selection of the environment-computation refresh rate is made on a periodic basis.
